(19) United States
(12) Patent Application Publication
(10) Pub. No.: US 2016/0239412 A1
(43) Pub. Date: Aug. 18, 2016

(54) STORAGE APPARATUS AND INFORMATION PROCESSING SYSTEM INCLUDING STORAGE APPARATUS

(71) Applicant: KABUSHIKI KAISHA TOSHIBA, Tokyo (JP)

(72) Inventor: Shintaro WADA, Bunkyo Tokyo (JP)

(21) Appl. No.: 14/836,873

(22) Filed: Aug. 26, 2015

(30) Foreign Application Priority Data
Feb. 17, 2015 (JP) 2015-028631

(51) Int. Cl. G06F 12/02; G06F 3/06

(52) U.S. Cl. CPC G06F 12/0253; G06F 12/0246; G06F 3/0608; G06F 3/0652; G06F 3/0688; G06F 2212/1044; G06F 2212/7205

(57) ABSTRACT

A storage apparatus comprises a plurality of storage devices that form a storage volume, a data buffer, and a first control unit that controls the storage apparatus and the data buffer. Each storage device includes a nonvolatile memory that includes a plurality of erasable memory blocks, and a second control unit that controls the nonvolatile memory. The second control unit is configured to execute a garbage collection process. The first control unit is configured to save in the data buffer data received by the storage apparatus for storage in a particular storage device when the data are received during a time period in which the particular storage devices is executing a garbage collection process, and write the data that are saved in the data buffer into the particular one of the plurality of storage devices after the garbage collection process is completed.

### CROSS-REFERENCE TO RELATED APPLICATION

This application is based upon and claims the benefit of priority from Japanese Patent Application No. 2015-028631, filed Feb. 17, 2015, the entire contents of which are incorporated herein by reference.

### FIELD

Embodiments described herein relate generally to a storage apparatus and an information processing system including the storage apparatus.

### BACKGROUND

An information processing system which includes a nonvolatile information storage apparatus using a memory element with a finite service life is known. This information processing system calculates update frequencies of an area of the information storage apparatus so as to determine the service life, and thus prevents a security function of the information storage apparatus from being degraded when the function of the information storage apparatus is invalidated at the end of the life.

### DESCRIPTION OF THE DRAWINGS

FIG. 1 is a diagram illustrating an example of a schematic configuration of a storage apparatus according to a first embodiment.

FIG. 2 is a diagram illustrating an example of an address table when writing data according to the first embodiment.

FIG. 3 is a diagram illustrating an example of the address table during reading data according to the first embodiment.

FIG. 4 is a diagram illustrating an example of the address table when rewriting data according to the first embodiment.

FIG. 5 is a timing chart illustrating an example of a process according to the first embodiment.

FIG. 6 is a diagram illustrating an example of the entire configuration of the information processing system according to a second embodiment.

FIG. 7 is a diagram illustrating an example of a schematic configuration of a host according to the second embodiment.

FIG. 8 is a diagram illustrating an example of a schematic configuration of a storage apparatus according to the second embodiment.

FIG. 9 is a timing chart illustrating an example of timing for a process according to the second embodiment.

FIG. 10 is a timing chart illustrating an example of timing for a process according to the second embodiment.

FIG. 11 is a diagram illustrating an example of the information processing apparatus including the storage apparatus.

FIG. 12 is a diagram illustrating another example of a schematic configuration of the storage apparatus.

### DETAILED DESCRIPTION

Embodiments provide a storage apparatus capable of preventing the degradation of writing performance with respect to a storage volume, and an information processing system including the storage apparatus.

According to an embodiment, a storage apparatus comprises a plurality of storage devices that form a storage volume, a data buffer, and a first control unit that controls the storage apparatus and the data buffer. Each storage device includes a nonvolatile memory that includes a plurality of erasable memory blocks, and a second control unit that controls the nonvolatile memory. The second control unit is configured to execute a garbage collection process. The first control unit is configured to save in the data buffer data received by the storage apparatus for storage in a particular storage device when the data are received during a time period in which the particular storage devices is executing a garbage collection process, and write the data that are saved in the data buffer into the particular one of the plurality of storage devices after the garbage collection process is completed.

In addition, according to another embodiment, a storage apparatus comprises a plurality of storage devices that form a storage volume, and a first control unit that controls the plurality of storage devices. Each of the plurality of storage devices includes a nonvolatile memory that includes a plurality of erasable memory blocks, and a second control unit that controls the nonvolatile memory. The second control unit is configured to (i) store a first threshold value, (ii) track garbage collection status information, the garbage collection status information indicating, for each of the erasable memory blocks in the nonvolatile memory, whether the erasable memory block is eligible for a garbage collection process, and (iii) when a ratio of a total number of erasable memory blocks eligible for the garbage collection process to all the erasable memory blocks of the nonvolatile memory is greater than the first threshold value, executing a garbage collection process in the nonvolatile memory.

Further, according to still another embodiment, an information processing system comprises a storage apparatus as described above, and a host. The host is configured to read data from and write data to the storage volume, monitor a writing performance for the storage volume in the storage apparatus, and when a monitoring result of the writing performance is greater than a threshold latency value, transmit a notification to the first control unit that the writing performance of the storage volume is degraded.

According to the embodiments, a storage apparatus and an information processing system may prevent the degradation of writing performance with respect to a storage volume.

### First Embodiment

Hereinafter, embodiments will be described.

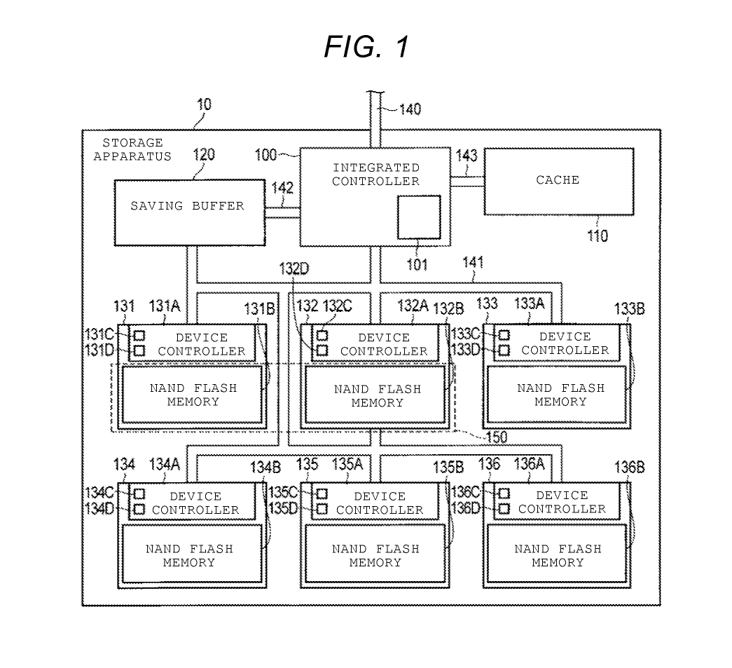

FIG. 1 is a diagram illustrating an example of a configuration of a storage apparatus according to a first embodiment.

As illustrated in FIG. 1, a storage apparatus 10 includes an integrated controller (a first control unit) 100, a cache 110, a saving buffer (a data storing unit) 120, and storage devices 131 to 136.

The integrated controller 100 is connected to a host (not shown) via a PCIe (PCI Express) interface 140. In addition, the integrated controller 100 is connected to the saving buffer 120 via a bus line 142, the storage devices 131 to 136 via a bus line 141, and the cache 110 via a bus line 143.

The storage devices 131 to 136 include device controllers 131A to 136A (a second control unit), respectively, and NAND flash memories (a nonvolatile memory) 131B to 136B, respectively. In addition, the device controllers 131A to 136A include block number management units 131C to 136C, respectively, and first threshold memory units 131D to 136D, respectively.

The integrated controller 100 controls the cache 110, the saving buffer 120, and the storage devices 131 to 136. More specifically, the integrated controller 100 writes data into the storage devices 131 to 136 based on a command from the host (not shown), and reads out the data from the storage devices 131 to 136.

Further, the integrated controller 100 includes the address table 101. When data are written into the saving buffer 120 during a data reorganization process, for example, a garbage collection (hereinafter, referred to as GC) process, a logical block address corresponding to the data is recorded in the address table 101. The integrated controller 100 executes a process for new data by using the address table 101, the cache 110, and the saving buffer 120 while the storage devices 131 to 136 execute the GC process. This process will be described later in detail.

Further, the integrated controller 100 manages each of the storage areas as one storage volume 150 in such a manner as to combine the storage device 131 and the storage device 132. That is, the integrated controller 100 provides five storage areas to the host (not shown), including the storage volume 150 and the storage devices 133 to 136. The storage volume 150 may be formed to include striping, which is a type of redundant arrays of inexpensive disks (RAID or redundant arrays of independent disks) from the storage devices 131 and 132. In addition, instead of the RAID, the storage volume 150 may include the storage devices 131 and 132 configured as, for example, just a bunch of disks (JBOD). In this way, there may be various methods for configuring the storage volume 150. In addition, while in the first embodiment the storage volume 150 is described as formed by the storage devices 131 and 132, the storage volume 150 may instead be configured in any arbitrary combination of the storage devices 131-136.

The cache 110 is used to temporarily store data, when the integrated controller 100 writes the data into the saving buffer 120 or the storage devices 133 to 136, or when the integrated controller 100 reads out the data from the saving buffer 120 or the storage devices 133 to 136. The cache 110 may include a nonvolatile memory, for example, a magneto resistive random access memory (MRAM). In addition, a speed of the writing performance of the cache 110 is generally selected to be faster than a speed of the writing performance of the NAND flash memories 131B to 136B.

The saving buffer 120 is a nonvolatile memory and is used when the GC process is executed. In the first embodiment, a memory capacity of the saving buffer 120 is the same as memory capacities of the NAND flash memories 131B to 136B. When the memory capacities of the NAND flash memories 131B to 136B are different from each other, the memory capacity of the saving buffer 120 is set to be larger than that of the NAND flash memory having the largest memory capacity. In addition, the saving buffer 120 may be formed of nonvolatile memory, for example, MRAM, such as that used for the cache 110. In addition, a speed of the writing performance of the saving buffer 120 is generally selected to be faster than a speed of the writing performance of the NAND flash memories 131B to 136B.

Next, the storage devices 131 to 136 will be described. The storage devices 131 to 136 have substantially the same configuration, and thus the storage device 131 is representatively described as an example.

The storage device 131 stores the data based on the control of the integrated controller 100. More specifically, based on the instruction of the integrated controller, the device controller 131A controls, for example, the writing and reading of the data with respect to the NAND flash memory 131B.

In the NAND flash memory 131B, the writing of the data, and the reading out of the data are executed units of one page, whereas the erasing of the data is executed in units of one block. Here, for example, one page is 2112 bytes, and one erasable memory block is 64 pages. Since the NAND flash memory 131B has the above-described properties, it is necessary to execute a process of maintaining continuously available storage areas by consolidating valid pages of data from erasable memory blocks that are partially or mostly filled with invalid (e.g., deleted) data. In other words, a process of reorganizing data in the storage area (the GC process) is routinely performed. During the GC process, the device controller 131A cannot write new data into the NAND flash memory 131B.

The device controller 131A stores the data in the NAND flash memory 131B, or reads out the data from the NAND flash memory 131B based on an instruction of the integrated controller 100.

In addition, regarding the NAND flash memory 131B, the device controller 131A is configured to execute a conversion process between a logical block address and a physical block address, a wear-leveling process, and the GC process. The wear-leveling process is a process of averaging the number of times of the writing of the data in the storage area, and the GC process is the process as described above.

The block number management unit 131C manages garbage collection status information indicating whether or not garbage collection corresponding to a specific erasable memory block is necessary. More specifically, the block number management unit 131C manages the block number (hereinafter, referred to as GC block number) representing the total number of erasable memory blocks that are eligible for the GC process, and a ratio of the GC block number to all the erasable memory blocks of the NAND flash memory 131B (hereinafter, referred to as a GC block number ratio). In the first embodiment, it is assumed that all the aforementioned block numbers (the storage areas) do not include spare blocks in the NAND flash memory 131B. Furthermore, an erasable memory block may be eligible for a garbage collection process when storing only invalid and/or obsolete data, or when storing more than a predetermined quantity of invalid and/or obsolete data.

The first threshold memory unit 131D stores the first threshold, which defines whether or not the GC process is executed in the NAND flash memory 131B. Specifically, when the ratio of the GC block number to the total number of erasable memory blocks of the NAND flash memory 131B reaches the first threshold, the GC process is executed in the NAND flash memory 131B.

In the first embodiment, the first threshold is set as 0.8, and this value may be commonly applied among each of the storage devices 131 to 136. However, in other embodiments, the first threshold may be set to be any value from 0 up to 1. In addition, when an amount of write data per unit time from the host (not shown) to the storage volume 150 is relatively large, i.e., greater than a predetermined maximum value, the first threshold of the storage devices 131 and 132 (which form the storage volume 150) may be set to a value smaller than the above-described first threshold 0.8, such as 0.75.

Alternatively or additionally, when an amount of write data per unit time from the host (not shown) to the storage volume 150 is relatively small, i.e., less than a predetermined minimum value, the first threshold of the storage devices 131 and 132 (which belong to the storage volume 150) may be set to a value that is larger than the above-described first threshold 0.8, such as 0.9. For example, in the above-described processes, the device controllers 131A and 131B change the thresholds of the respective first threshold memory units 131D and 132D based on the instruction of the integrated controller 100. If it is assumed that the amount of the write data per hour is large, it is possible to predict that the storage device reaches a state requiring the GC process in a short time, and thus for example, the first threshold may be set as a value smaller than 0.8. Accordingly, the writing performance is less likely to be degraded. In contrast, if the amount of the write data per hour is relatively small, the storage device is likely to take a longer time than the above time to reach a state requiring the GC process, and thus, for example, the first threshold may be set as a value larger than 0.8.

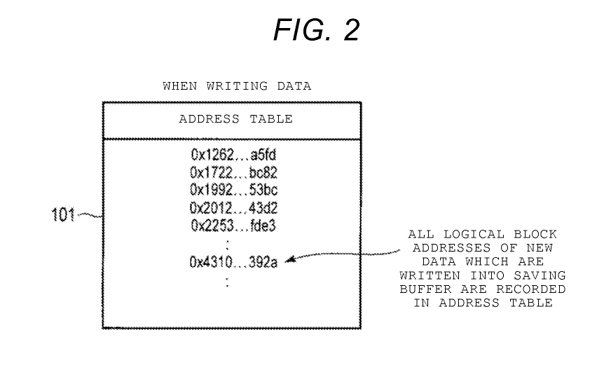

Next, an address table 101 will be described with reference to FIG. 2 to FIG. 4.

FIG. 2 is a diagram illustrating an example of the address table 101 employed when writing data. More specifically, FIG. 2 is a diagram illustrating an example of a method of managing the logical block addresses of such data before completing the GC process and when writing the data into the saving buffer 120.

As illustrated in FIG. 2, all of the logical block addresses of new data (or rewrite data) that are written into the saving buffer 120 are recorded in the address table 101. For example, when the storage device 131 is executing the GC process, it is not possible to write the new data into the storage device 131. For this reason, the new data are written into the saving buffer 120. At this time, the logical block address of the new data is recorded into the address table 101.

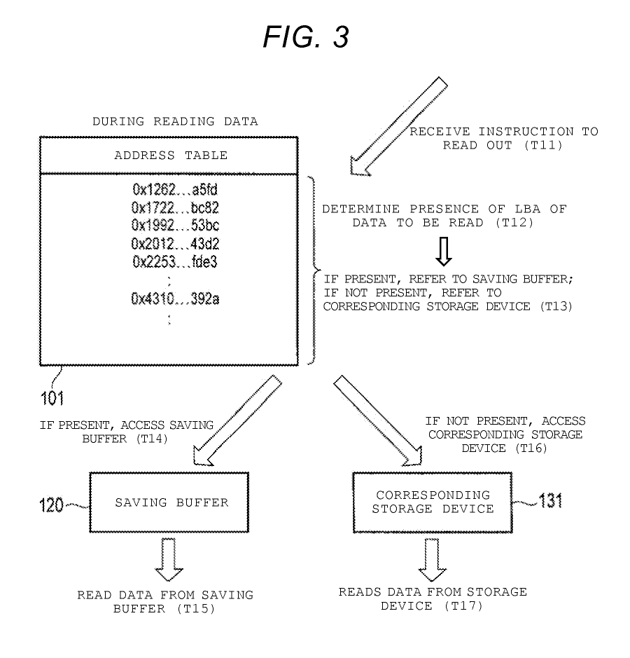

FIG. 3 is a diagram illustrating an example of the address table 101 during reading of data. More specifically, FIG. 3 is a diagram illustrating an example of a method of managing the logical block address of read data before completing the GC process and during reading out of the data.

As illustrated in FIG. 3, when the integrated controller 100 receives an instruction to read out the data from the storage devices 131 to 136 from the host (not shown) (T11), the integrated controller 100 detects whether or not the logical block address of data to be read out is present in the address table 101 (T12). When the logical block address is present, the integrated controller 100 refers to the saving buffer 120, and when the logical block address is not present, the integrated controller 100 refers to the corresponding storage device among the storage devices 131 to 136 (hereinafter, referred to as the storage device) (T13).

When the logical block address is present in the address table 101, the integrated controller 100 accesses the saving buffer 120 (T14). The integrated controller 100 reads out the data corresponding to the logical block address from the saving buffer 120 (T15). The read data are then transmitted to the host (not shown).

On the other hand, when the logical block address is not present in the address table 101, the integrated controller 100 accesses the storage device (T16). The integrated controller 100 reads out the data corresponding to the logical block address from the storage device (T17). The read data are then transmitted to the host (not shown).

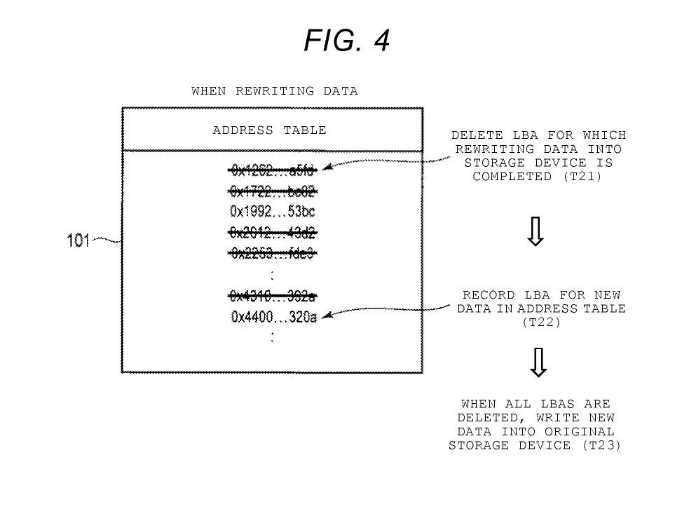

FIG. 4 is a diagram illustrating an example of the address table when rewriting data. More specifically, FIG. 4 is a diagram illustrating an example of a method of managing the logical block address of the data after completing the GC process and when the data saved in the saving buffer 120 is stored in the corresponding storage device.

When the integrated controller 100 completes the rewriting data into the logical block address which is managed by the address table 101 from the saving buffer 120, the logical block address corresponding to such data is deleted from the address table 101, in other words, is cleared (T21). Meanwhile, FIG. 4 illustrates deleting by drawing a line through the logical block address.

In addition, until the rewriting of the data that are saved in the saving buffer 120 is completed, new data are not written in the storage device during the rewriting, and instead the new data are written (saved) in the saving buffer 120. For this reason, even when a rewriting process is in progress, the logical block address corresponding to new data is recorded (addition) in the address table 101 (T22).

When all of the logical block addresses recorded in the address table 101 are deleted, the saved data in the saving buffer 120 are transmitted to the original storage device, and then the rewriting is completed. Hereinafter, the new data are written not into the saving buffer 120, but are written into the original storage device (T23).

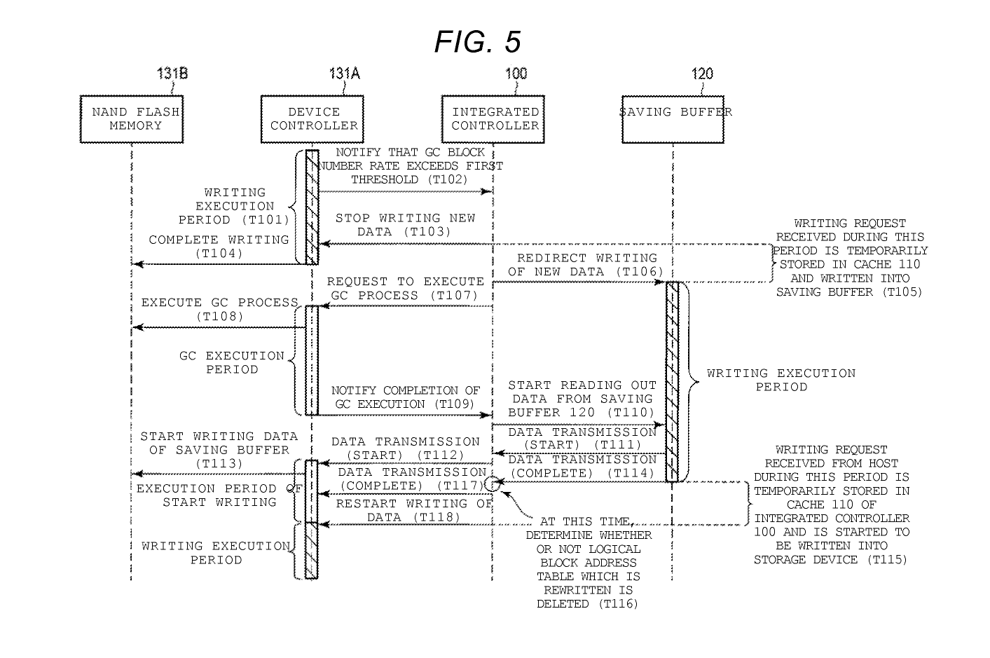

FIG. 5 is a timing chart illustrating an example of a process of the integrated controller 100 and the device controller 131A at the time of executing the GC process. In addition, an example is described of a case in which the storage device 131 that includes a portion of the storage volume 150 requires the GC process during a period of writing execution (i.e., a time period in which a write command is received from a host) (T101).

The device controller 131A causes the block number management unit 131C to manage the GC block number and the GC block number ratio for the storage device 131 during a period of writing data. Then, the device controller 131A determines whether or not the GC block number ratio exceeds the first threshold (0.8, for example) during execution of the data writing. When it is determined that the GC block number ratio exceeds the first threshold, the device controller 131A notifies the integrated controller 100 that the GC block number ratio exceeds the first threshold (a first notification) (T102). This notification is, in other words, the notification that the garbage collecting process is necessary.

When the integrated controller 100 receives the first notification, the integrated controller 100 stops writing additional new data into the device controller 131A (T103). This is because data cannot be written into the storage device 131 due to the GC process.

Further, after a predetermined time passes, the writing of the last data of the data which are being written into the NAND flash memory 131B is completed prior to the GC process being executed (T104).

Next, the integrated controller 100 redirects the writing of new data that are to be written to the storage device 131 to the saving buffer 120 (T106: saving means). Because of this, the new data are written into the saving buffer 120. Meanwhile, if an additional writing request is received from the host prior to the setting of the redirect (T104), the integrated controller 100 temporarily stores the writing request in the cache 110 and then writes the writing request into the saving buffer 120 (T105).

Next, the integrated controller 100 requests (instructs) the device controller 131A to execute the GC process (T107). If the request (instruction) is received, the device controller 131A executes the GC process in the NAND flash memory 131B (T108: execution means).

Then, when the GC process is completed, the device controller 131A notifies the integrated controller 100 that the GC process is completed (for example, via a second notification) (T109). This notification is, in other words, the notification that the garbage collecting process is completed.

When receiving the notification of completion (the second notification), the integrated controller 100 starts reading out the saving buffer 120 (T110). Because of this, the data are transmitted to the integrated controller 100 from the saving buffer 120 (T111), and then the data are transmitted to the device controller 131A from the integrated controller 100 (T112). At this time, the logical block address corresponding to the data to be transmitted is deleted from the address table 101.

The device controller 131A writes the transmitted data (the data in the saving buffer 120) into the NAND flash memory 131B (T113: writing means). In this way, when receiving the notification of completion of the GC process, the saved data in the saving buffer 120 are written into the storage device 131 that is the source of the notification. This process is executed while the data are transmitted from the saving buffer 120 via the integrated controller 100.

Then, when the last data are transmitted from the saving buffer 120 (T114), the integrated controller 100 determines whether or not all of the logical block addresses are being deleted (blanks in the table) from the address table 101 (T116). If logical block addresses are not completely deleted from the address table 101, there is a possibility that the transmitted data are not the last data stored in the saving buffer 120 that are associated with new data to be written to the storage device 131 and stored in saving buffer 120 at T106. Accordingly, a predetermined error process is executed, including rewriting of said data (T118). If an additional write request is received from the host during the writing execution period in which rewriting data occurs (T118), the additional write request from the host is temporarily stored in the cache 110 of the integrated controller 100 (T115), and the additional write request is subsequently executed in the storage device 131.

If the logical block addresses are not being completely deleted from the address table 101, the last data are transmitted to the device controller 131A from the integrated controller 100 (T117). Then, the device controller 131A writes the last data into the NAND flash memory 131B. Because of this, the process of writing the data saved in the saving buffer 120 into the NAND flash memory 131B (the period of the writing of data) is completed.

As described above, after the period of the writing of data ends, when the integrated controller 100 receives the writing request from the storage device 131, the data are written into the device controller 131A again (T118). The period in which the writing request is executed is the writing period.

Meanwhile, if the GC block number ratio of another storage device 132 which forms the storage volume 150 exceeds the first threshold 0.8, after all of the logical block addresses are deleted from the address table 101, the process which is substantially the same process as the aforementioned process (T101 to T128) is executed by the device controller 132A and the integrated controller 100. In some embodiments, it is optional whether or not the GC process from any of the storage devices 131 and 132 is executed, so that a GC process in both (or all) storage devices included in storage volume 150 is not performed simultaneously.

According to the storage apparatus 10 as described above, for the storage volume 150 including the storage devices 131 and 132, when the GC block number ratio of any one of the storage devices 131 and 132 exceeds the first threshold (e.g., 0.8), the GC process is automatically executed. For this reason, regarding the storage devices 131 and 132 which form the storage volume 150, the number of erasable memory blocks which require the GC process is increased, and therefore, the degradation of the writing performance may be autonomously resolved. Accordingly, the writing performance of one storage device 131 (or 132) which forms the storage volume 150 is improved, and thus it is possible to prevent the writing performance of the entire storage volume 150 in advance from being degraded.

In addition, the storage apparatus 10 temporarily stores writing of new data with respect to the storage device 131 which is in the middle of the GC process in the saving buffer 120 under the management of the address table 101, and then may write the temporarily stored data into the storage device 131 after the GC process is completed.

Further, the storage apparatus 10 may temporarily store new write data in the cache 110 during the period in which writing the new data is redirected (T106) after the writing of the new data is stopped (T103), and during the period in which the writing of the data is restarted (T118) from the last data transmission (T114).

In addition, the storage apparatus 10 uses, for example, an MRAM for the cache 110 and the saving buffer 120. The write latency of MRAM is in the order of 10 nanoseconds. On the other hand, the write latency of the NAND flash memories 131B and 132B is generally on the order of milliseconds. For this reason, the MRAM may write data at a speed higher than the NAND flash memories 131B and 132B. Accordingly, the storage apparatus 10 may prevent the degradation of the writing performance with respect to the storage volume 150 during execution of the GC process, even if the cache 110 and the saving buffer 120 is used during the GC process.

A description of an embodiment is provided in more detail by way of an example. In this example, the NAND flash memories 131B and 132B of the storage devices 131 and 132 which form the storage volume 150 are assumed to have the writing performance of an average write latency of 0.1 ms and a maximum write latency of 100 ms.

In addition, it is assumed that at a particular time during operation, a write latency of the storage device 131 is 50 ms (for example due to degraded write performance of the storage device 131), while a write latency of the storage device 132 is 0.1 ms (for example when the storage device 132 is without degradation of writing performance.

In this case, the write latency of the entire storage volume 150 is 50 ms, due to the degradation of the writing performance of the storage device 131. Thus, when compared to the case where the writing performance of the entire storage volume 150 is not degraded in the storage devices 131 and 132, the write latency is increased 500 times (from 0.1 ms to 50 ms).

By contrast, for an embodiment of the storage apparatus 10 in the first embodiment, if the writing performance of the storage device 131 is degraded (for example, when the GC block number ratio is greater than the first threshold), the new data to be written to the storage device 131 is not immediately written into the storage device 131. Instead, the storage apparatus 10 executes the writing of the new data in the cache 110 or the saving buffer 120, either of which may write the new data at a speed higher than the NAND flash memory 131B. For this reason, the write latency of the storage volume 150 is maintained at about 0.1 ms, which is the average write latency of the storage device 132. Accordingly, it is possible to prevent the writing performance of the storage volume 150 from being degraded, even when the write performance of one of the storage devices included in the storage volume 150 has degraded write performance.

In addition, even if an abnormality such as a power-off occurs in the storage apparatus 10 during the above-described process (refer to FIG. 5), the storage apparatus 10 may avoid data loss by using the MRAM (the nonvolatile memory) in the cache 110 and the saving buffer 120.

In the first embodiment, the storage volume 150 is formed of two storage devices, that is, the storage devices 131 and 132. However, the storage volume 150 may alternatively be formed of three or more storage devices. The storage volume 150 may include, for example, four storage devices such as RAID 1+0, five storage devices such as RAID 5, or six storage devices such as RAID 6.

### Second Embodiment

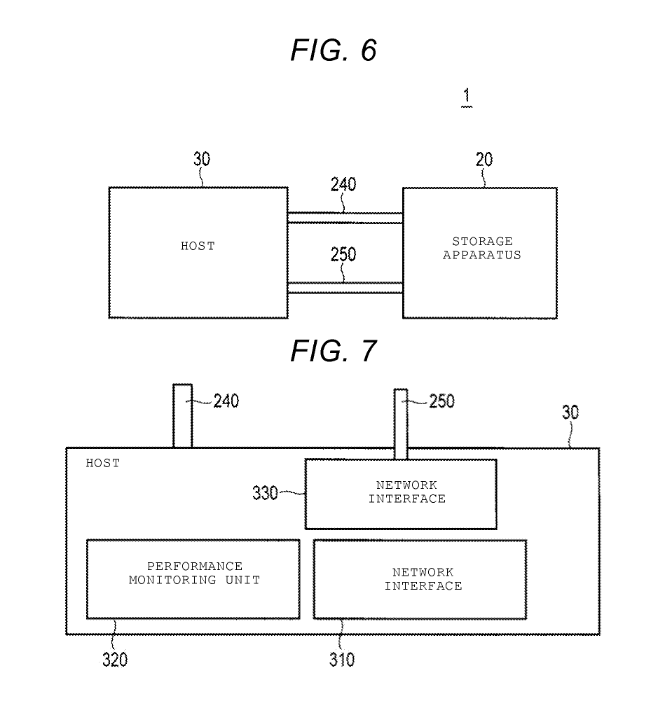

FIG. 6 is a diagram illustrating a configuration of the information processing system 1 according to a second embodiment. As illustrated in FIG. 6, the information processing system 1 includes a storage apparatus 20 and a host 30. In addition, the storage apparatus 20 and the host 30 are connected to each other via a PCIe interface 240 and a LAN for management (Local Area Network) 250.

FIG. 7 is a diagram illustrating an example of a configuration of the host 30. As illustrated in FIG. 7, the host 30 includes an application unit 310, a performance monitoring unit (a host control unit) 320, and a network interface 330.

The application unit 310 controls the writing of the data with respect to the storage apparatus 20, and the reading out of the data from the storage apparatus 20.

The network interface 330 is connected to the storage apparatus 20 via the LAN for management 250.

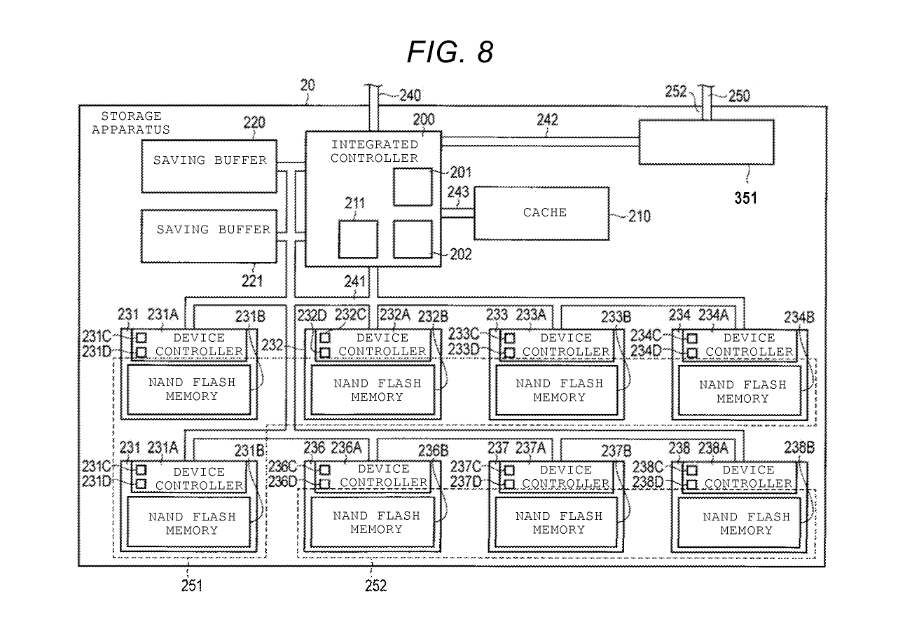

The performance monitoring unit 320 measures the write latency with respect to the storage volumes 251 and 252 (described below) of the storage apparatus 20 from the host 30. In addition, the performance monitoring unit 320 determines whether or not the writing performance of the storage volumes 251 and 252 satisfies predetermined conditions. Further, when the writing performance of the storage volumes 251 and 252 satisfies the predetermined conditions for the writing, the performance monitoring unit 320 notifies the integrated controller 200 (will be described later) of the storage apparatus 20 that the writing performance of the storage volumes 251 and 252 satisfies the predetermined conditions (a third notification, e.g., a notification of performance degradation) via a network interface 351 (shown in FIG. 8). Here, the predetermined conditions mean conditions for determining that the writing performance of the storage volume is degraded (described in detail below). Accordingly, this notification may be, in other words, the notification that the writing performance of a particular storage volume is degraded.

FIG. 8 is a diagram illustrating an example of a configuration of the storage apparatus 20. As illustrated in FIG. 8, the storage apparatus 20 includes an integrated controller 200, a cache 210, saving buffers 220 and 221, storage devices 231 to 238, and a network interface 351.

The integrated controller 200 includes address tables 201 and 202, and a second threshold memory unit 211.

The storage devices 231 to 238 include device controllers 231A to 238A, respectively, and NAND flash memories 231B to 238B, respectively. In addition, the device controllers 231A to 238A include block number management units 231C to 238C, respectively, and first threshold memory units 231D to 238D, respectively. As described above, the configurations of the storage devices 231 to 238 are substantially the same as the configuration of the storage device 131 according to the first embodiment, therefore, the detailed description thereof will be omitted.

The integrated controller 200 is connected to the saving buffers 220 and 221, and the storage devices 231 to 238 via a bus line 241, is connected to the network interface 351 via a bus line 242, and is connected to a cache 210 via a bus line 243. In addition, the integrated controller 200 is connected to the host 30 via the PCIe interface 240, the network interface 351, and the LAN for management 250.

The integrated controller 200 controls the cache 210, the saving buffers 220 and 221, and the storage devices 231 to 238. More specifically, the integrated controller 200 writes data into the storage devices 231 to 238, or reads out the data from the storage devices 231 to 238 based on a command from the host 30.

The configurations of the cache 210, the address tables 201 and 202, and the saving buffers 220 and 221 are substantially the same as the configurations of the cache 110, the address table 101, and the saving buffer 120, respectively, according to the first embodiment, therefore, the detailed description thereof will be omitted.

The second threshold memory unit 211 stores a second threshold which defines at what ratio of the GC block number of a particular one of NAND flash memories 231B to 238B (i.e., the number of erasable memory blocks in the particular NAND flash memory requiring the GC process) to the total number of erasable memory blocks of the particular NAND flash memory the GC process is executed in the particular NAND flash memory. Note that, in some embodiments, it is assumed that the aforementioned GC block numbers do not include spare blocks in the NAND flash memories 231B to 238B. In the second embodiment, the second thresholds of all of the NAND flash memories 231B to 238B are typically set at 0.8. However, in other embodiments, the second threshold may be set to any value that is greater than 0 and less than 1.

In addition, the second threshold that is stored in the second threshold memory unit 211 may be changed based on a type of an application (program), a use state of the application (the program), a specific time, a specific period of time, and/or an I/O load during execution of the application. The host 30 may instruct the integrated controller 20 to change the second threshold via the LAN for management 250. In the second embodiment, the host 30 may set the second threshold for the storage volumes 251 and 252.

The integrated controller 200 manages each of the storage areas as one storage volume 251 in such a manner as to combine the storage devices 231 to 235, and manages each of the storage areas as one storage volume 252 in such a manner as to combine the storage device 236 to 238. That is, the integrated controller 100 provides two storage areas to the host 30: the storage volumes 251 and 252 (a pair of the plurality of storage devices). The storage volumes 251 and 252 may include various RAID, or may be JBOD. Each of these storage volumes may be any of the various configurations described above for the storage volume 150 according to the first embodiment.

In addition, when receiving from the host 30 a notification that the writing performance of a predetermined storage volume is equal to or less than a pre-determined value (a third notification), the integrated controller 200 executes procedures for resolving the degradation of the writing performance of storage volume. For example, when receiving the above-described notification relating to the storage volume 251 from the host 30, the integrated controller 200 acquires the GC block number ratio for each of the storage devices 231 to 235 (which form the storage volume 251), and executes the GC process on a storage device that exceeds the second threshold.

Next, in the above-described information processing system 1, a process executed by the performance monitoring unit 320 will be described, when the application unit 310 of the host 30 executes the writing and reading of data with respect to the storage volumes 251 and 252 in the storage volume unit.

The performance monitoring unit 320 periodically executes a 4096-byte writing test on the storage volume in which the host 30 executes the writing and reading of data, for example, the storage volume 251, and measures the write latency of the storage volume 251. A period of the write test is set to a specific time interval, for example, once every 20 seconds. In addition, the latency of writing access at the i-th measurement is assumed to establish L (i)=2 ms. The measurement of the latency L (i) is executed by subtracting the time when the writing command is issued from the time when the writing of data into the target storage devices (i.e., the storage devices 231 to 235) is completed.

In some embodiments, the performance monitoring unit 320 calculates an average value A (i) of latency values in the last, for example, 100 times from the i-th L (i) to the i-th L (i−99). Based on the average value A(i), the performance monitoring unit 320 can generate a threshold latency value for writing test latency. For example, in some embodiments, such a threshold latency value may be equal to the above-described average value A (I) time a predetermined factor, e.g., 20. In some embodiments, the predetermined factor is not fixed and is adjustable. By way of example, the average value A (i) which is obtained at the i-th measurement may be 0.3 ms. The performance monitoring unit 320 calculates a latency L (i+1) by executing (i+1)-th measurement when the next writing test is executed in the storage volume 251. At this time, a result of L (i+1)=61 ms is obtained. At the same time, assuming that the performance monitoring unit 320 uses 20×A (i) as a threshold T (i+1) of the latency, the threshold T (i+1) at this time becomes 6 ms. In some embodiments, because 61 ms is greater than the threshold latency value of 6 ms, and the host 30 notifies the integrated controller 200 that writing degradation has occurred, and the integrated controller 200 executes procedures for resolving the degradation of the writing performance of storage volume. In other embodiments, the integrated controller 200 executes such procedures when the threshold latency value is exceeded in two consecutive writing tests, as described below.

Continuing the above example, if the latency L (i+1) is greater than T (i+1) when comparing the latency L (i+1) with the threshold T (i+1), the performance monitoring unit 320 determines that the latency exceeds the threshold. This time, L (i+1):T (i+1)=61:6 is established, which means the value of latency is greater than the threshold, whereby it is determined that the latency exceeds the threshold. In the next measurement, 70 ms of latency is measured, and if T (i+2) is calculated by recalculating the threshold, the value of 18 ms is obtained, for example. The respective values become L (i+2):T (i+2)=70:18, and then it is determined that the latency value associated with the writing test exceeds the threshold latency value for writing test latency again. In this way, the performance monitoring unit 320 determines that the degradation of the writing performance occurs in the storage volume 251, because the threshold latency value for writing test latency is detected for two consecutive times (which in some embodiments may be considered the above-described predetermined conditions).

The performance monitoring unit 320 notifies the integrated controller 200 that, for example, the writing performance of the storage volume 251 is degraded (the third notification) when it is determined that the writing performance of the storage volume 251 is degraded. The integrated controller 200 recognizes that the degradation of the writing performance occurs in the storage volume 251 upon receipt of the notification.

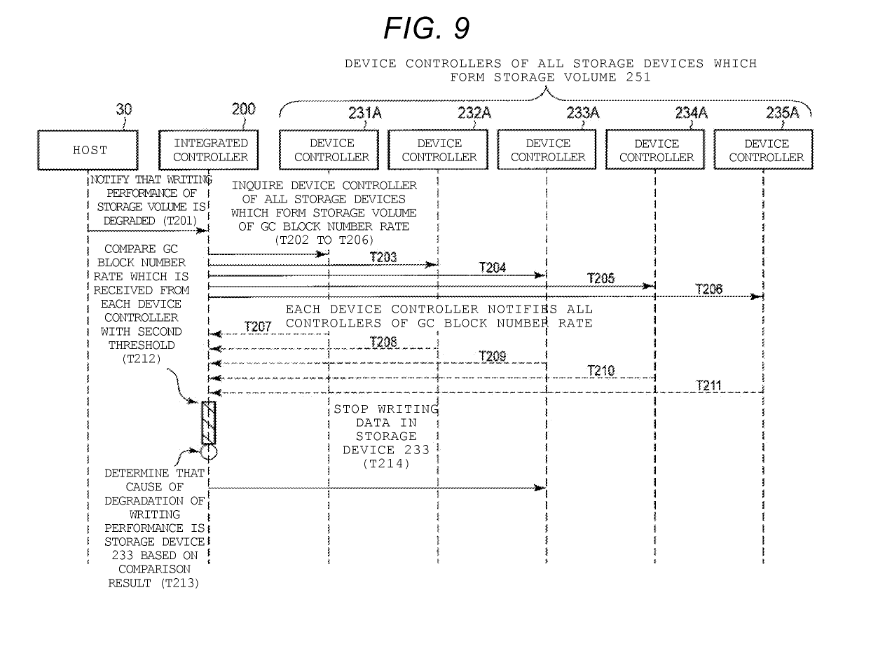

FIG. 9 is a timing chart illustrating an example of timing for a process when the performance monitoring unit 320 determines that degradation of the writing performance occurs in the storage volumes 251 and 252. Hereinafter, a case in which the performance monitoring unit 320 determines the degradation of the writing performance of the storage volume 251 will be described.

The performance monitoring unit 320 notifies the integrated controller 200 that the writing performance of the storage volume 251 is degraded (the third notification) (T201: performance degradation notifying means). When receiving this notification, the integrated controller 200 requests the GC block number ratio of all the storage devices 231 to 235 which form the storage volume 251 (T202 to T206). That is, the integrated controller 200 requests the GC block number ratio from each of the device controllers 231A to 235A.

Each of the device controllers 231A to 235A of the storage devices 231 to 235, which receives the above inquiry returns the GC block number ratio which is managed in the block number management units 231C to 235C to the integrated controller 200 (T207 to T211). In this way, the integrated controller 200 acquires the block number ratio from the storage devices 231 to 235 (acquiring means).

When receiving the GC block number ratio from the device controllers 231A to 235A, the integrated controller 200 compares the GC block number ratio which is received from each of the device controllers 231A to 235A with the second threshold (e.g., 0.8) of the storage volume 251, which is stored in the second threshold memory unit 211 (T212). In the following discussion, it is assumed that, by way of example, only the GC block number ratio received from device controller 233A exceeds the second threshold.

Based on the comparison result, the integrated controller 200 determines that the cause of the degradation of the writing performance of the storage volume 251 is the storage device 233 (T213). Next, the integrated controller 200 stops writing the data in the storage device 233 (T214).

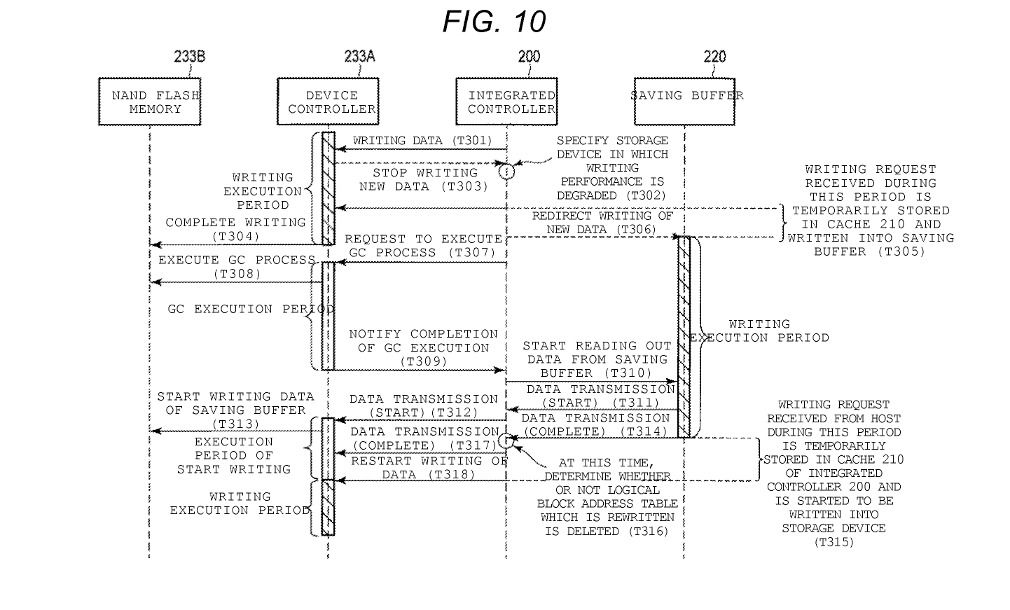

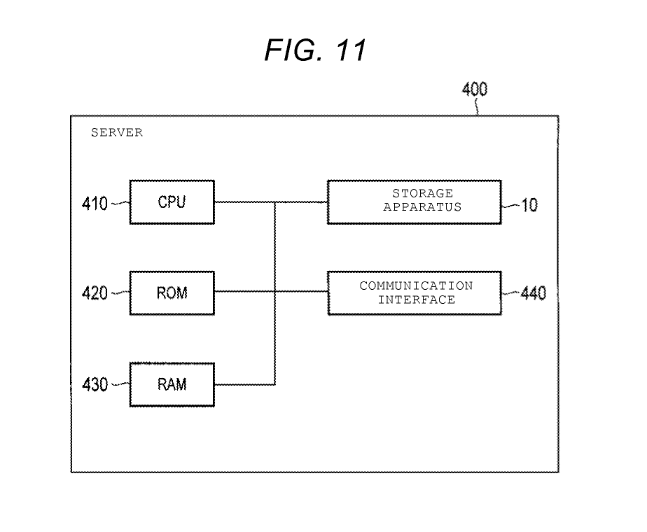

FIG. 10 is a timing chart illustrating an example of a process of the integrated controller 100 and the device controller 233A when receiving the notification of the degradation of the writing performance.

During the writing of data into the storage volume 251 (which includes the storage device 233) (T301), the integrated controller 200 specifies that the cause of the degradation of the writing performance of the storage volume 251 (the storage device in which the writing performance is degraded) is the storage device 233 (T302) based on the notification from the performance monitoring unit 320 of host 30. These processes are described above in conjunction with FIG. 9.

Next, the integrated controller 200 stops writing the data into the storage device 233 (T303). Processes after T303, that is, process T303 to T318 are substantially the same, respectively, as the processes T103 to T118 described in FIG. 5, thus the description thereof will be omitted. Meanwhile, the process T307 corresponds to output means for outputting the instruction to perform the GC process.

According to the information processing system 1 configured as described above, when the writing performance of the storage volume 251 is equal to or less than a writing performance determination value, the integrated controller 200 acquires the GC block number ratio of the storage devices 231 to 235 (which form the storage volume 251), and the acquired GC block number ratio may cause the storage device (hereinafter, referred to as a target storage device) to exceed the second threshold to execute the GC process. For this reason, it is possible to resolve the degradation of the writing performance of the storage volume 251.

Description will be made in more detail by referring to an example. The NAND flash memories 231B to 235B of the storage devices 231 to 235 (which form the storage volume 251) are assumed in this example to have an average write latency of 0.1 ms and a maximum write latency of 100 ms.

In addition, in this example it is assumed that (1) the GC block number ratio of a NAND flash memory 233B of the storage device 233 exceeds the second threshold (e.g., 0.8 in the second embodiment), and (2) the write latency of the storage device 233 is 50 ms.

In this case, in the related information processing system, the write latency of the entire storage volume 251 is 50 ms due to the degradation of the writing performance of the storage device 233. In this case, when comparing the case where the writing performance is not degraded in the storage device 233, the write latency is increased by a factor of 500 (0.1 ms: 50 ms).

In contrast, according to the information processing system 1 of the second embodiment, when the writing performance of the storage volume 251 that includes the storage device 233 is equal to or less than the writing performance determination value (also referred to as the threshold latency value) or less, since the GC block number ratio of the storage device 233 is considered to exceed the second threshold, the GC process of the storage device 233 is executed. Furthermore, the writing of new data is not executed in the storage device 233. Instead of this, the storage apparatus 20 executes the writing of the data in the cache 210 or the saving buffer 220, and each of which may write the data at a speed higher than the NAND flash memory 233B. For this reason, the write latency of the storage volume 251 is reduced to 0.1 ms, which corresponds to the average write latency of each of the storage devices 231 to 235, that is, a value obtained by adding overhead of computing parity.

Because of this, the application unit 310 which reads out data from the storage volume 251 may prevent the increase in response time caused by the delay of the writing with respect to the storage volume 251, the degradation of processing throughput, and the occurrence of an I/O time out error.

In addition, in some embodiments, the storage apparatus 20 includes two saving buffers 220 and 221 instead of a single saving buffer, and two address tables 201 and 202 instead of a single address table. Accordingly, for example, when it is determined the GC block number ratio of two storage devices among the five storage devices 231 to 235 forming the storage volume 251 exceeds the second threshold (e.g., 0.8), the integrated controller 200 captures new write data with respect to the two storage devices, and allocates the two saving buffers 220 and 221 and the two address tables 201 and 202 to each storage device, thereby writing data into the appropriate saving buffer.

More specifically, in this example, it is assumed that the integrated controller 200 determines that the GC block number ratio of the two storage devices 231 and 232 among the storage devices 231 to 235 which form the storage volume 251 exceeds the second threshold. In this case, the integrated controller 200 writes new data to be written in the storage device 231 into the saving buffer 220. At this time, the integrated controller 200 executes the management of the logical block address relating to the new data to be written in the storage device 231 in accordance with the address table 201. In addition, the integrated controller 200 writes the new data to be written in the storage device 232 into the saving buffer 221. At this time, the integrated controller 200 executes the management of the logical block address relating to the new data to be written in the storage device 232 in accordance with the address table 202. Therefore, it is possible to improve write latency of two of the storage devices concurrently in the storage apparatus 20.

Meanwhile, when the writing performance for the storage volume 252 is equal to or less than the writing performance determination value (threshold latency value), the saving buffers 220 and 221 may be employed during a GC process executed in one or two of the storage devices among the storage device 236 to 238 (which form the storage volume 252).

In addition, in the second embodiment, the configuration of the storage apparatus 20 that is described includes two saving buffers 220 and 221, and two address tables 201 and 202 corresponding respectively to the two saving buffers 220 and 221, but the configuration is not limited thereto. Three or more saving buffers and address tables corresponding to the saving buffers may be included in the storage apparatus 20. Because of this, even when the GC process is necessary for three or more storage devices in one storage volume, the process may be executed at the same time, and thus it is possible to improve write latency of any number of storage devices concurrently in the storage apparatus 20.

Further, the saving buffer 220 and the address table 201 may be employed for new data to be saved in the storage volume 251, and the saving buffer 221 and the address table 202 may be employed for new data to be saved in the storage volume 252. Because of this, the information processing system 1 may concurrently execute the process in two or more storage volumes.

Furthermore, although a case of using the PCIe 240 as the I/O interface between the storage apparatus 20 and the host 30 is described, the I/O interface is not limited to the PCIe 240. For example, instead of the PCIe, FCoE and iSCSI using FC-SAN such as Fiber-Channel, and Ethernet (trade mark) may be used as the I/O interface between the storage apparatus 20 and the host 30.

Note that, although the notification that the writing performance of the storage volumes 251 and 252 is equal to or less than the writing performance determination value (threshold latency value) is executed via the LAN for management 250, the notification may be executed by using the PCIe. Similarly, the notification that the second threshold is changed from the host 30 to the storage apparatus 20 may be executed through various interfaces.

Further, in the second embodiment, although the storage apparatus 20 is described to be the external storage apparatus of the host 30, the storage apparatus 20 is not limited thereto. For example, the storage apparatus 20 may be applied to any information processing apparatus that includes the storage apparatus. Examples of such an information processing apparatus include a server, a personal computer, a mobile terminal device, a tablet terminal, and the like. Meanwhile, FIG. 11 is a diagram illustrating an example of a schematic configuration of a server 400 into which the storage apparatus is incorporated. As illustrated in FIG. 11, the server 400 includes a CPU 410, a ROM 420, a RAM 430, the storage apparatus 10, and a communication interface 440.

In addition, each of the storage apparatus 10, the storage apparatus 20, and the host 30, as described above, may function as a computer. For this reason, some embodiments are implemented as a program, and may be provided to such computers as a non-transitory computer-readable medium. The program causes the process described in the first embodiment to be achieved in the storage apparatus 10. Alternatively or additionally, the program may cause the process described in the second embodiment to be achieved in the storage apparatus 20 and the host 30, which form the information processing system 1. In such embodiments, the programs received from an external device or via the network are respectively stored in a predetermined storage area in the storage apparatus 10, a predetermined storage area in the storage apparatus 20, and/or a predetermined storage area in the host 30. The programs stored as described above may be executed by the CPUs associated with the integrated controllers 100 and 200, the device controllers 131A to 136A and 231A to 238A, and/or the host 30. Meanwhile, in a configuration in which the storage apparatuses 10 and 20 and/or the host 30 receives the programs from the an external device may be applied to the techniques in related art.

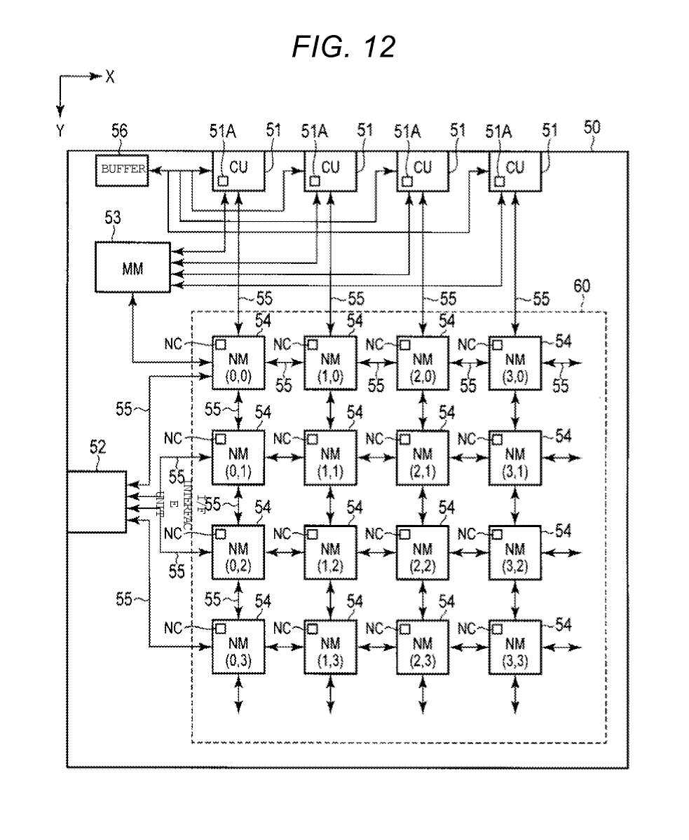

FIG. 12 is a diagram illustrating an example of a schematic configuration of a storage apparatus 50. In some embodiments, the storage apparatus 10 may be implemented with the configuration illustrated in FIG. 12.

As illustrated in FIG. 12, the storage apparatus 50 includes a memory unit 60, one or more connection units (CU) 51, an interface unit (I/F unit) 52, a management module (MM) 53, and a buffer 56.

The memory unit 60 includes a plurality of node modules (NM) 54, which respectively have a memory function and a data transmitting function, and are connected to each other via a mesh network as shown. The memory unit 60 stores data in such a manner as to disperse items of data across the plurality of NMs 54. The data transmitting function includes a transmitting method in which each of the NMs 54 efficiently transmits packets of data.

FIG. 12 illustrates an example of a rectangular network in which each of the NMs 54 is disposed at a lattice point of thereof. Coordinates of the lattice point are represented by coordinates (x, y), position information of the NM 54 at the lattice point is represented by a node address (xD, yD) corresponding to the coordinates of the lattice point. In addition, in the example of FIG. 12, the NM 54 positioned in the top left corner includes the node address (0, 0) at the original point, and the node address of each of the NMs 54 is incremented accordingly as a function of the location of the NM 54 in the horizontal direction (in the X direction) and the vertical direction (in the Y direction), whereby the node address is increased and decreased with an integer value.

Each of the NMs 54 includes two or more interfaces 55. Each NM 54 is connected to each adjacent NM 54 via an interface 55. Thus, NMs 54 may be connected to adjacent NMs 54 in two or more different directions. For example, the NM 54 which is associated with the node address (0, 0) in the top left corner in FIG. 12 is connected to the NM 54 associated with the node address (1, 0) adjacent in the X direction and the NM 54 associated with the node address (0, 1) adjacent in the Y direction which is different from the X direction. In addition, the NM 54 associated with the node address (1, 1) in FIG. 12 is connected to four NMs 54, which are indicated by the node addresses (1, 0), (0, 1), (2, 1) and (1, 2), and are adjacent thereto in the four different directions.

In FIG. 12, each of the NMs 54 is disposed at the lattice point that is part of a rectangular lattice configuration, but each of the NMs 54s is not limited to being disposed at lattice points in such a lattice configuration. That is, the lattice shape may be formed by connecting each of the NMs 54 disposed at the lattice point and the NMs 54 that are adjacent thereto, using, for example, a triangular or hexagonal shaped lattice configuration. In addition, each of the NMs 54 is arranged in a two-dimensional configuration in the FIG. 1, but each of the NMs 54 may instead be arranged in a three-dimensional configuration. When the NMs 54 are arranged in a three-dimensional configuration, each of the NMs 54 may be designated using three values (x, y, and z). In addition, when the NM 54 is two-dimensionally disposed, the NMs 54 may be connected to each other in a torus shape, by connecting the NMs 54 that are positioned on opposite sides of the lattice to each other.

In addition, each of the NMs 54 may include an NC (a node controller). The NC receives a packet from the CU 51 or other NMs 54 via the interface 15, or transmits a packet to the CU 51 or other NMs 54 via the interface unit 52. In addition, when the destination of the transmitted packet is its own NM 54, the NC executes a process in response to the packet (a command recorded in the packet). For example, if the command is an access command (a read command or a write command), the NC executes an access to a first predetermined memory. When the destination of the transmitted packet is not its own NM 54, the NC transmits the packet to another NM 54 that is connected to its own NM 54.

The CU 51 includes a connector which is connected to the outside and may input and output data to the memory unit 60 in accordance with a request from an external device. Specifically, the CU 51 includes the storage area and a computing device (not shown in the drawings), and the computing device may execute a server application program while using the storage area as a work area. The CU 51 processes the request from the external device under the control of the server application. The CU 51 executes the access to the memory unit 60 in the course of processing a request from the external device. When accessing memory unit 60, the CU 51 generates a packet which may be transmitted or executed by the NM 54, and the generated packet is transmitted to the NM 54 that is connected to its own CU 51.

In the example of FIG. 12, the storage apparatus 50 includes four CUs 51. The four CUs 51 are connected to each of the NMs 54. Here, the four CUs 51 are respectively connected to a node (0,0), a node (1,0), a node (2,0), and a node (3,0). Note that, in some embodiments, the number of the CUs 51 may be selected for optimal performance of storage apparatus 50. In addition, the CUs 51 may be connected to the NMs 54 that are selected to form the storage apparatus 10. In addition, one CU 51 may be connected to the plurality of NMs 54, and a single NM 54 may be connected to the plurality of the CUs 51. In addition, the CU 51 may be connected to an arbitrary NM 54 among the plurality of NMs 54 forming the storage apparatus 10.

In addition, the CU 51 includes a cache 51A. The cache 51A temporarily stores data when the CU 51 executes various processes.

The buffer 56 temporarily stores data when the CU 51 stores data with respect to the NM 54. In addition, the data stored in the buffer 56 is stored in a predetermined NM 54 by the CU 51 at a predetermined time.

Next, communication between the storage apparatus 50, configured as illustrated in FIG. 12, and the storage apparatus 10 (refer to FIG. 1) as illustrated in the first embodiment will be described.

The integrated controller 100 corresponds to the plurality of CUs 51 (four CUs 51 in FIG. 12). The cache 110 corresponds to the cache 51A. The saving buffer 120 corresponds to the buffer 56. The storage devices 131 to 136 correspond to six NMs 54. The device controller 20 corresponds to the NC in the NM 54.

Therefore, the processes executed by the storage apparatus 10 as described herein may also be executed by the storage apparatus 50.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage apparatus comprising:
a plurality of storage devices that form a storage volume;
a data buffer; and
a first control unit that controls the storage devices and the data buffer,
wherein each of the plurality of storage devices includes
a nonvolatile memory that includes a plurality of erasable memory blocks, and
a second control unit that controls the nonvolatile memory,
wherein the second control unit is configured to execute a garbage collection process, and
wherein the first control unit is configured to save in the data buffer data received by the storage apparatus for storage in a particular one of the plurality of storage devices when the data are received during a time period in which the particular one of the plurality of storage devices is executing a garbage collection process, and
write the data that are saved in the data buffer into the particular one of the plurality of storage devices after the garbage collection process is completed.

2. The storage apparatus of claim 1, wherein the first control unit is further configured to:
store a threshold ratio value;
receive the notification from a host that the writing performance of the storage volume is degraded;
in response to receiving the notification, acquire, for each storage device included in the storage volume, a ratio of a number of erasable memory blocks in the storage device eligible for a garbage collection process to a total number of erasable memory blocks in the storage device; and
when the ratio for a particular storage device included in the storage volume is greater than the threshold ratio value, cause the second control unit of the particular storage device to initiate a garbage collection process in the particular storage device.

3. The storage apparatus of claim 2, wherein the total number of erasable memory blocks in the storage device excludes spare erasable memory blocks.

4. The storage apparatus of claim 2, wherein the storage volume of the storage apparatus includes two or more of the plurality of storage devices.

5. The storage apparatus of claim 2, wherein the writing performance corresponds to a writing latency of the storage volume.

6. The storage apparatus of claim 1, wherein the data buffer comprises an additional nonvolatile memory that is separate from the nonvolatile memory.

7. The storage apparatus of claim 6, wherein a writing speed of the additional nonvolatile memory is faster than a writing speed of the nonvolatile memory in the storage device.

8. The storage apparatus of claim 1, wherein the plurality of storage devices are configured as a redundant array of independent disks (RAID).

9. The storage apparatus of claim 1, wherein the plurality of storage devices are configured as just a bunch of disks (JBOD).

10. A storage apparatus comprising:
a plurality of storage devices that form a storage volume; and
a first control unit that controls the plurality of storage devices,
wherein each of the plurality of storage devices includes
a nonvolatile memory that includes a plurality of erasable memory blocks, and
a second control unit that controls the nonvolatile memory,
wherein the second control unit is configured to
(i) store a first threshold value,
(ii) track garbage collection status information, the garbage collection status information indicating, for each of the erasable memory blocks in the nonvolatile memory, whether the erasable memory block is eligible for a garbage collection process, and
(iii) when a ratio of a total number of erasable memory blocks eligible for the garbage collection process to all the erasable memory blocks of the nonvolatile memory is greater than the first threshold value, executing a garbage collection process in the nonvolatile memory.

11. The storage apparatus according to claim 10, further comprising a data buffer, and wherein the first control unit is configured to:
save in the data buffer data received by the storage apparatus for storage in a particular one of the plurality of storage devices when the data are received during a time period in which the particular one of the plurality of storage devices is executing a garbage collection process, and
write the data that are saved in the data buffer into the particular one of the plurality of storage devices after the garbage collection process is completed.

12. The storage apparatus according to claim 11, wherein the data buffer comprises an additional nonvolatile memory that is separate from the nonvolatile memory.

13. The storage apparatus according to claim 12, wherein a writing speed of the additional nonvolatile memory is faster than a writing speed of the nonvolatile memory in the storage device.

14. The storage apparatus according to claim 10, wherein the plurality of storage devices are configured as a redundant array of independent disks (RAID).

15. The storage apparatus according to claim 10, wherein the plurality of storage devices are configured as just a bunch of disks (JBOD).

16. The storage apparatus according to claim 10, wherein the first control unit is configured to decrease the first threshold value when an amount of write data per unit time received from a host by the storage apparatus is greater than a predetermined maximum value.

17. The storage apparatus according to claim 10, wherein the first control unit is configured to increase the first the threshold value when an amount of write data per unit time received from a host by the storage apparatus is less than a predetermined minimum value.

18. An information processing system comprising:
a storage apparatus including a plurality of storage devices that form a storage volume and a first control unit that controls the plurality of storage devices, wherein each of the plurality of storage devices includes a nonvolatile memory that includes a plurality of erasable memory blocks and a second control unit that controls the nonvolatile memory, and wherein the second control unit is configured to
(i) store a first threshold value,
(ii) track garbage collection status information, the garbage collection status information indicating, for each of the erasable memory blocks in the nonvolatile memory, whether the erasable memory block is eligible for a garbage collection process, and
(iii) when a ratio of a total number of erasable memory blocks eligible for the garbage collection process to all the erasable memory blocks of the nonvolatile memory is greater than the first threshold value, executing a garbage collection process in the nonvolatile memory; and
a host that is configured to
read data from and write data to the storage volume,
monitor a writing performance for the storage volume, and
when a monitoring result of the writing performance is greater than a threshold latency value, transmit a notification to the first control unit that the writing performance of the storage volume is degraded.

19. The information processing system according to claim 18, wherein the threshold latency value is based on a predetermined number of previous monitoring results associated with the storage volume.

20. The information processing system according to claim 18, further comprising a data buffer, and wherein the first control unit is configured to:
save in the data buffer data received by the storage apparatus for storage in a particular one of the plurality of storage devices when the data are received during a time period in which the particular one of the plurality of storage devices is executing a garbage collection process, and
write the data that are saved in the data buffer into the particular one of the plurality of storage devices after the garbage collection process is completed.
